(19) United States
(12) Patent Application Publication
(10) Pub. No.: US 2002/0145536 A1
(43) Pub. Date: Oct. 10, 2002

(54) Method and apparatus for wirelessly disabling electronic devices

(75) Inventor: William E. Clise, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Locate Networks, Inc.

(21) Appl. No.: 10/079,064

(22) Filed: Feb. 20, 2002

Related U.S. Application Data
(63) Continuation of application No. 09/587,213, filed on Jun. 1, 2000, now abandoned.

(51) Int. Cl. G08C 19/00

(52) U.S. Cl. 340/825.72

(57) ABSTRACT

A system for remotely controlling the operation of electronic equipment. A wireless broadcast transceiver communicates with electronic devices having corresponding wireless reception transceivers. The wireless broadcast transceiver transmits signals which inform the electronic device that it is not to operate within a specific zone or during a particular time. The wireless transceivers are preferably compatible with the Bluetooth™ wireless communication protocol that operates within a limited range using low power. In one environment, the transceivers disable electronic equipment on an aircraft during take off and landing.

### FIELD OF THE INVENTION

The present invention relates to electronic systems, and in particular to systems for remotely prohibiting the use of electronic devices.

### BACKGROUND OF THE INVENTION

In many locations, it is undesirable or dangerous to operate electronic devices. Examples of such locations include blasting areas, in aircraft during takeoff and landing, and in areas containing potentially explosive vapors, such as near gas pumps or in operating rooms. As the use of consumer electronic devices, such as personal computers, handheld computers, cellular telephones, pagers and portable dictating machines etc. become more prevalent, the likelihood that such devices could cause interference with sensitive communication systems or trigger an explosion increases.

In the past, there has been no reliable method of ensuring that such certain electronic devices are not used within a sensitive area or during inappropriate times. Signs may be posted around RF sensitive areas. Similarly, announcements are typically made on aircraft informing passengers of the type of electronic devices that may be used and when. Both these techniques rely on the voluntary compliance of the device operators. Given this problem, there is a need for a system that can reliably ensure that the use of electronic devices can be controlled in dangerous environments or at specific times.

### SUMMARY OF THE INVENTION

The present invention comprises a low power wireless transceiver that communicates with one or more electronic devices in order to cause such devices to become disabled in RF sensitive areas or during times when the operation of such devices is prohibited. In the presently preferred embodiment of the invention, the wireless transceiver comprises a Bluetooth™ transceiver that transmits wireless signals to devices that also include Bluetooth™ transceivers. The present invention can be incorporated into aircraft cabins, to disable cellular phones or other electronic devices during takeoff and landing. In addition, the present invention can also be used in RF sensitive areas such as in blasting areas, around gas pumps, operating rooms, etc., to ensure that electronic devices that enter these areas are disabled.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a wireless system for disabling electronic devices according to one embodiment of the present invention; and

FIG. 2 illustrates the use of the present invention in an aircraft.

### DETAILED DESCRIPTION OF THE PREFERRED EMBODIMENT

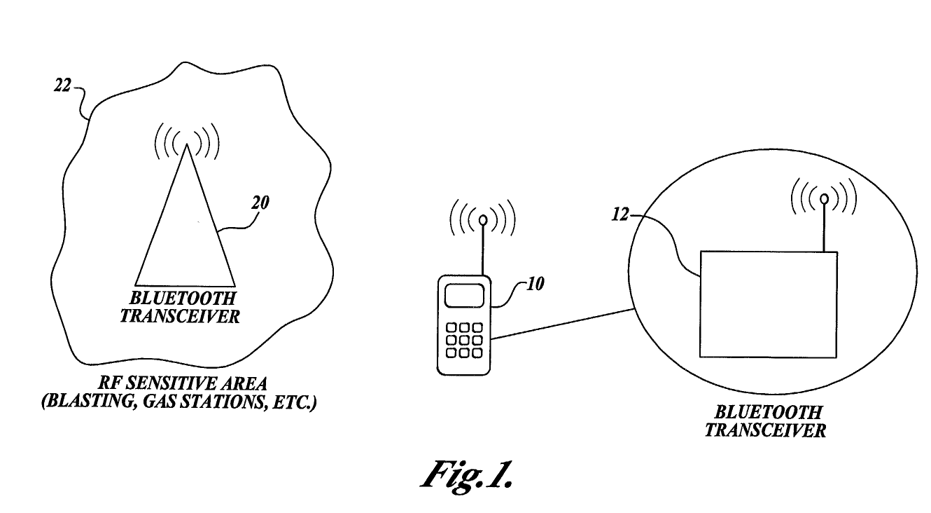

The present invention is a system for remotely controlling the operation of electronic devices. As shown in FIG. 1, an electronic device 10, such as a cellular telephone, pager, personal audio system, hand held computer, laptop computer or other portable device, is equipped with a low power wireless reception transceiver 12 that allows radio frequency (RF) signals to be transmitted to and received from the electronic device 10. In accordance with the present invention, a corresponding broadcast wireless transceiver 20 is located in an RF sensitive area 22 in which it is desirable to control the operation of the electronic device 10. For example, the RF sensitive area 22 may include blasting areas, gas stations, operating rooms or other environments where it is potentially dangerous to operate the electronic device 10.

RF signals received by the reception transceiver 12 control the operation of the electronic device 10 such that when the electronic device is within range of the broadcast transceiver 20, the electronic device 10 becomes disabled.

In the presently preferred embodiment of the invention, the transceivers 12 and 20 operate in accordance with the Bluetooth™ transmission protocol which is becoming a widely accepted standard for communication among electronic devices using low power radio frequency signals. Because the Bluetooth™ communications signals are transmitted using very low power, the potential that such signals will interfere with sensitive communications equipment or pose a hazard is small. The Bluetooth™ communications protocol standard can be obtained from the Internet site www.bluetooth.com and is herein incorporated by reference. Numerous corporations such as Ericsson are currently developing Bluetooth™ transceivers that can be incorporated into a variety of electronic devices.

Although the transceiver 12 is referred to as the reception transceiver, it will be appreciated that it preferably has the ability to transmit signals to the broadcast transceiver 20 as it receives signals from the broadcast transceiver 20. However, it will be appreciated that the present invention can be implemented whereby the transceiver 20 only has the ability to transmit and the transceiver only has the ability to receive.

The wireless broadcast transceiver 20 preferably transmits a “do not operate” signal at regular intervals. The electronic device that is equipped with a corresponding reception transceiver 12 is programmed to disable itself upon the detection of a “do not operate” signal. The device 10 is further programmed to remain disabled while the “do not operate” signals are received. If a “do not operate” signal is not received within a predetermined time, the device 10 is free to operate.

Alternatively, the wireless broadcast transceiver 20 may transmit “do not operate” signals when the operation of the electronic device 10 is prohibited and “ok to operate” signals when operation of the device is allowed.

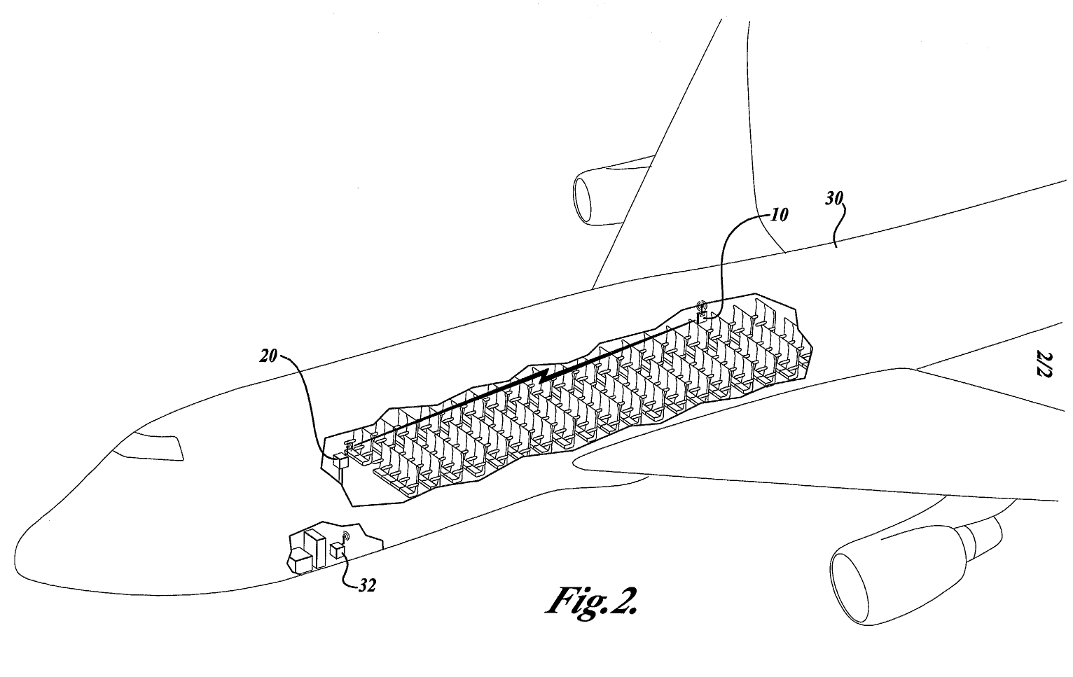

FIG. 2 illustrates one specific example of an environment in which the present invention is utilized. Here, an aircraft 30 is equipped with the wireless broadcast transceiver 20 that communicates with one or more electronic devices 10. In particular, the electronic devices include cellular telephones, computers, electronic games or other devices that can interfere with the aircraft's communication and guidance systems. During takeoff, a pilot or other crewmember causes the broadcast transceiver 20 to transmit low power signals to each electronic device 10 within the aircraft, causing certain devices to remain disabled during certain time periods such as takeoff or landing. In addition, certain types of equipment such as cellular telephones, pagers or other radios may be disabled for the entire flight. The broadcast transceiver 20 can also communicate with electronic instruments 32 or devices that may be stored within a cargo compartment. The wireless broadcast transceiver 20 interacts with the devices 32 to make sure that they remain off during flight.

As can be seen, the present invention provides a simple mechanism for ensuring that electronic devices are not operated in RF sensitive areas or during times where the use of the devices may be dangerous through the use of a low power wireless communication link. The present invention is not limited to prohibiting electronic device operation in RF sensitive areas or in airplanes. For example, the present invention could also be used in movie theatres, symphony halls, restaurants, churches, or other environments where it is desirable to limit the use of potentially annoying electronic devices.

While the present invention has been disclosed with respect to its preferred embodiments, it will be appreciated that changes can be made without departing from the scope of the invention. The scope of the invention is therefore to be determined from the following claims and equivalents thereto.

The embodiments of the invention in which an exclusive property or privilege is claimed are defined as follows:

1. A system for remotely controlling the operation of electronic devices, comprising:
a broadcast transceiver that transmits wireless low power signals to one or more electronic devices, wherein said signals indicate whether the electronic device may operate or not;
a reception transceiver coupled to the electronic device for receiving the signals from the broadcast transceiver, wherein the reception transceiver interacts with the electronic device to disable it upon the receipt of a signal from the broadcast transceiver.

2. The system of claim 1, wherein the electronic device is a cellular telephone.

3. The system of claim 1, wherein the broadcast and reception transceivers transmit and receive signals according to the Bluetooth™ wireless protocol.

4. The system of claim 1, wherein the broadcast transceiver and electronic device are located in an airplane.

5. The system of claim 1, wherein the broadcast transceiver and the electronic device are in an RF sensitive area.

6. The system of claim 1, wherein the broadcast transceiver periodically transmits a signal indicating that an electronic device should not be operated and wherein the reception transceiver receives the signals and allows the electronic device to operate if a signal indicating the device should not operate is not received in a predetermined period of time.

7. The system of claim 1, wherein the broadcast transceiver transmits signals indicating that an electronic device may operate, and signals indicating that the device may not operate, wherein the electronic device is disabled upon receipt of a signal transmitted from the broadcast transceiver indicating the device should not operate and enabled upon receipt of a signal transmitted from the broadcast transceiver indicating the device may operate.

8. A portable electronic device, the improvement comprising:
a wireless transceiver within the device that receives signals from a remote broadcast transceiver, the wireless transceiver disabling the electronic equipment upon receipt of a signal from the broadcast transceiver to disable the device.

9. The portable device of claim 8, wherein the wireless transceiver communicates in accordance with the Bluetooth communications protocol.
